(19) United States
(12) Patent Application Publication
(10) Pub. No.: US 2014/0085197 A1
(43) Pub. Date: Mar. 27, 2014

(54) CONTROL AND VISUALIZATION FOR MULTI TOUCH CONNECTED DEVICES

(71) Applicant: Navin Patel, Brampton (CA)

(72) Inventor: Navin Patel, Brampton (CA)

(73) Assignee: ATI TECHNOLOGIES, ULC, Markham (CA)

(21) Appl. No.: 13/624,564

(22) Filed: Sep. 21, 2012

(51) Int. Cl. G06F 3/041; G06F 3/02; G06F 3/033

(52) U.S. Cl. 345/157

(57) ABSTRACT

A method and device for facilitating interaction between a touch screen device and a computing device are provided. The method includes displaying a pointer location indicator (mouse cursor) on the touch screen device. The mouse cursor moves responsively to movement of a mouse of a linked computing device. The device includes a touch screen having an input operable to receive indications of operation of a pointing device coupled to a second computing device. The touch screen is further operable to display a pointer location indicator and the pointer location indicator is operable to move responsively to movement of the pointing device.

### FIELD OF THE DISCLOSURE

The present disclosure is related to methods and devices for providing visualization and control for connected devices via devices that do not natively have such controls. More specifically, the present disclosure is related to providing controls for remotely operating a touchscreen using non-touchscreen type controls.

### BACKGROUND

Testing, maintaining, or otherwise operating one or more touchscreen devices, such as tablet computers is sometimes performed via connected computers. Such interaction is described in U.S. patent application Ser. No. 13/313,286 filed Dec. 7, 2011 titled Method and Apparatus for Remote Extension Display, the disclosure of which is expressly incorporated herein by reference. Additionally, programming and testing of applications designed to run on such devices are performed on non-touch-screen devices that are unable to natively replicate the inputs (such as touch, specifically multi-touch gestures) expected to be encountered by the applications. Testing of the devices and applications may require testing of such inputs to ensure proper operation.

Accordingly, there exists a need for non-touch screen devices to have the ability to replicate the touch inputs that are expected to be encountered by the devices and/or applications being controlled and/or programmed for.

### BRIEF DESCRIPTION OF THE DRAWINGS

FIG. 1 is a diagram showing a coupled PC and touch screen device; and

FIG. 2 is a flow chart showing operation of the touch screen device of FIG. 1.

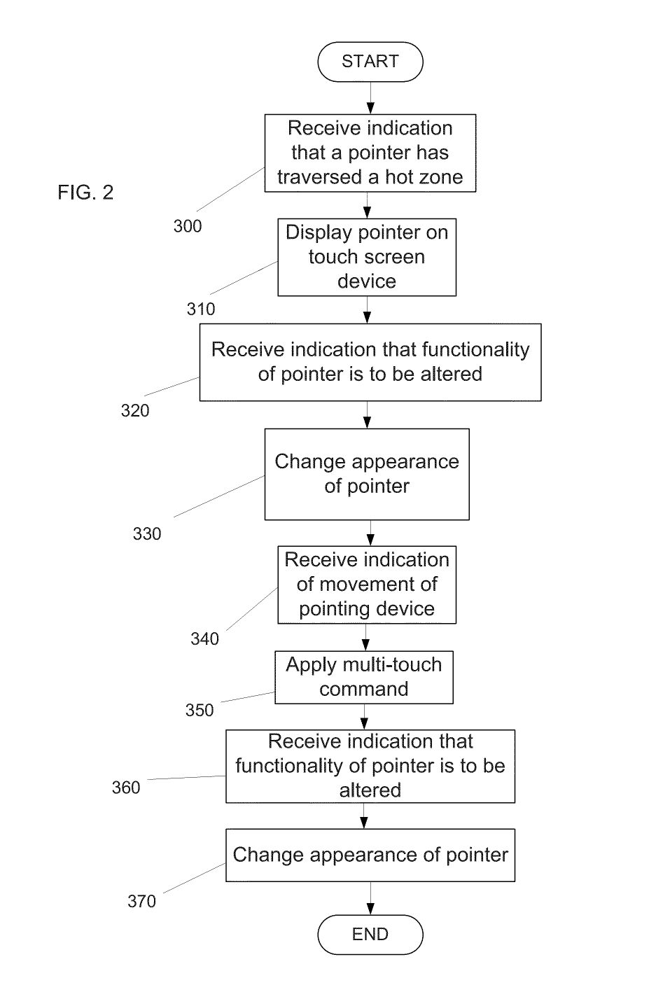

### DETAILED DESCRIPTION OF EMBODIMENTS

In an exemplary and non-limited embodiment, aspects of the invention are embodied in a method of interacting with a touch screen device. The method includes displaying a pointer location indicator (mouse cursor) on the touch screen device. The mouse cursor moves responsively to movement of a mouse of a linked computer.

In another exemplary embodiment, a touch screen device is provided including an input operable to receive indications of operation of a pointing device coupled to a second computing device; and a touch screen operable to display a pointer location indicator, the pointer location indicator operable to move responsively to movement of the pointing device.

In yet another exemplary embodiment, a computer readable medium is provided containing non-transitory instructions thereon. When the instructions are interpreted by at least one processor they cause the at least one processor to display a pointer location indicator on the touch screen device, the pointer location indicator operable to move responsively to movement of a pointing device of a second computing device.

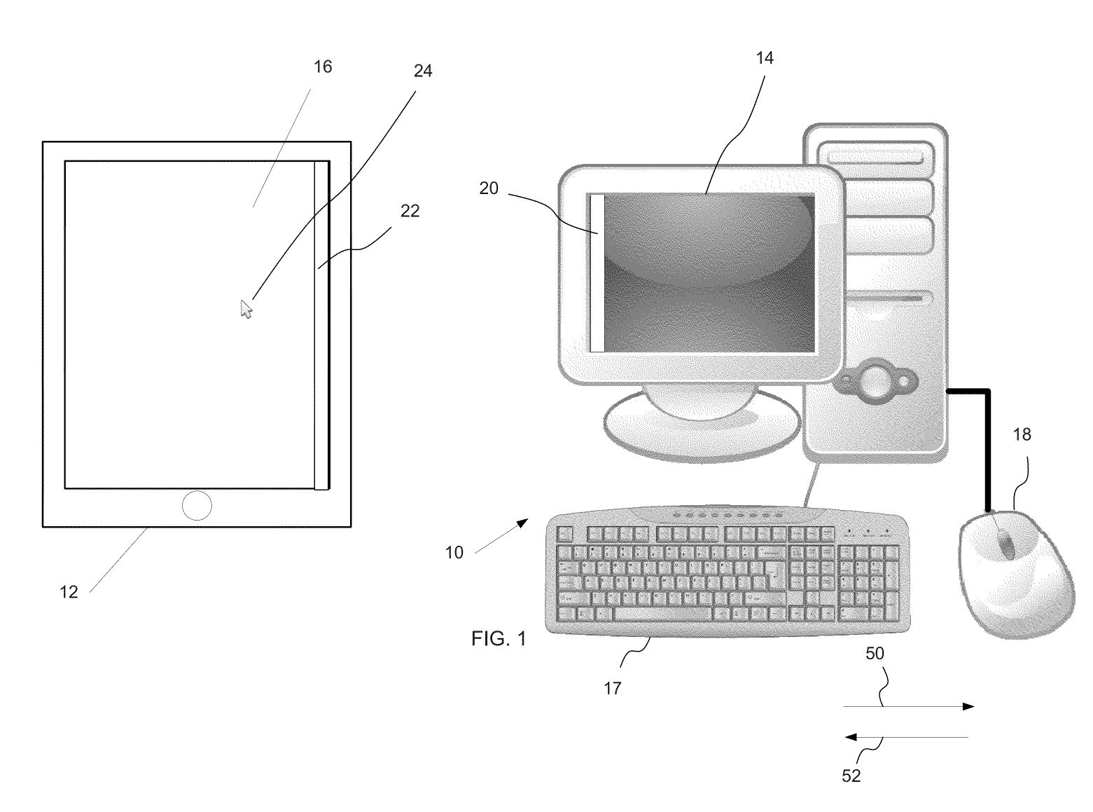

FIG. 1 shows PC 10 and touch screen device 12 (illustratively tablet 12). PC 10 includes display/screen 14, keyboard 17, and mouse pointer 18.

As described in U.S. patent application Ser. No. 13/313,286 filed Dec. 7, 2011 titled Method and Apparatus for Remote Extension Display, screens 14, 16 of PC's 10, tablets 12, phones, or other computing devices can be linked. Such linking provides that screen 16 of tablet 12 acts as an extension of screen 14 of PC 10.

One embodiment of linked screens includes the use of hot zones 20, 22 of respective displays 14, 16. Hot zones 20, 22 provide that when mouse pointer 24 traverses them in a given direction, further movement in that direction off of screen 14 causes pointer 24 to appear on linked screen 16. In one embodiment, movement of pointer 24 across hot zone 20 of PC screen 14, block 300, causes pointer 24 to show up on screen 16 of touch screen tablet 12, block 310. It should be appreciated that mouse 18 continues to control the location of pointer 24 on screen 16. Whereas tablet 16 does not natively provide for pointer 24, one is provided to account for the fact that tablet 16 is being remotely controlled rather than controlled via its touch screen.

Touch screen tablet 12 provides that touching screen 16 is able to replicate many pointing tasks typically performed by a mouse pointer 18. For example, a tap on touch screen 16 can replicate a click of mouse pointer 18. Similarly, moving a finger that maintains contact with touch screen 16 can replicate a click and drag operation of mouse 18. Given these similar operations, appearance and operation of pointer 24 on touch screen 16 is intuitive for a user and relatively seamless in application.

However, touch screen 16, and specifically those capable of recognizing multiple simultaneous touches also provide interactions that are not always provided for by pointing and clicking mouse 18. One such example is the multi-touch gesture of starting with two fingers together and dragging fingers that are spreading apart (zoom-in) and starting with two fingers apart and dragging the fingers together (zoom-out). Accordingly, once mouse 18 and pointer 24 are employed on touch screen 16, a user is left without a way to invoke functionality and gestures that are native to the touch-screen.

The present devices include drivers that provide for intuitive controls that replicate inputs native to touch screens 16. The drivers employed may be part of or separate from drivers employed to provide the hot zone functionality and screen extension functionality.

The drivers provide for mapping various features native to touch screen 16 to various keys of keyboard 17. Examples of operations to be mapped include tap, double tap, long press, scroll, pan, flick, two finger tap, two finger scroll, pinch (two touch pinch), spread (two touch spread), and rotate (two touch rotate).

Additionally, a combination of keyboard and mouse operations can be mapped to provide operations. In one such example, a user presses the “left arrow” key and then conducts a click and drag of mouse 18 to the right (arrow 50) to accomplish a two touch spread. This movement provides an intuitive movement that simulates the two touch spread on a touch screen. Like the native two touch spread, a user is increasing distance between two parts of the user's body that are performing the interaction. Similarly, to perform a two touch pinch, a user presses the right arrow button while performing a click drag of mouse 18 to the left (arrow 52). Again, this movement provides an intuitive movement that simulates the two touch pinch on a touch screen. Alternatively, a single arrow key can be used for both the pinch and spread functions such that movement of the mouse provides both functionalities without requiring different keyboard buttons. The above examples assume a right side/right handed mouse user. Because the functionality is embodied in software, settings can be manipulated to make the movements intuitive from the perspective of a left-hand mouse user as well. Similar keyboard and mouse movement combinations are envisioned to perform other touch screen functions such as object rotation.

In addition to providing functionality native to touch screen 16 via keyboard 17 and mouse 18, pressing keys or buttons that have been mapped to the functionality also dictate that mouse pointer 24 changes in appearance to provide a visual indication that the various functionality has been invoked. For example, upon pressing the keys and buttons necessary to invoke the multi touch spread, touch screen 16 receives an indication that the key(s)/button(s) was pushed, block 320. Pointer 24 could change to look like two arrows pointing away from each other, block 330. Upon seeing such an icon on touch screen 16, the user knows the movement of mouse 18 will result in effecting the two touch spread command. Thus, movement of mouse 18 is communicated to and received by touch screen 16, block 340. This movement causes touch screen 16 to apply the multi-touch command of multi-touch spread, block 350. Upon release of the key(s)/button(s) such release is communicated to and received by touch screen device 16, block 360. Touch screen device 16 then reverts the appearance of mouse pointer 24 to its “normal” state, block 370.

In one example, pressing keys or buttons that have been mapped to functionality causes an icon to appear fixed at the location of the pointer 24. For so long as the key or button is pressed, the fixed icon remains. Subsequent movement while the icon is present results in a zoom (in or out) and/or rotation. Release of the key/button causes disappearance of the icon.

The above detailed description and the examples described therein have been presented for the purposes of illustration and description only and not for limitation. For example, the operations described may be done in any suitable manner. The method may be done in any suitable order still providing the described operation and results. It is therefore contemplated that the present embodiments cover any and all modifications, variations or equivalents that fall within the spirit and scope of the basic underlying principles disclosed above and claimed herein. Furthermore, while the above description describes hardware in the form of a processor executing code, hardware in the form of a state machine, or dedicated logic capable of producing the same effect are also contemplated.

The software operations described herein can be implemented in hardware such as discrete logic fixed function circuits including but not limited to state machines, field programmable gate arrays, application specific circuits or other suitable hardware. The hardware may be represented in executable code stored in non-transitory memory such as RAM, ROM or other suitable memory in hardware descriptor languages such as but not limited to RTL and VHDL or any other suitable format. The executable code when executed may cause an integrated fabrication system to fabricate an IC with the operations described herein

Also, integrated circuit design systems/integrated fabrication systems (e.g., work stations including, as known in the art, one or more processors, associated memory in communication via one or more buses or other suitable interconnect and other known peripherals) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic, software, and circuits described herein may also be produced as integrated circuits by such systems using the computer readable medium with instructions stored therein. For example, an integrated circuit with the aforedescribed software, logic, and structure may be created using such integrated circuit fabrication systems. In such a system, the computer readable medium stores instructions executable by one or more integrated circuit design systems that causes the one or more integrated circuit design systems to produce an integrated circuit.

What is claimed is:

1. A method of interacting with a touch screen device including:
displaying a pointer location indicator on the touch screen device, the pointer location indicator operable to move responsively to movement of a pointing device of a second computing device.

2. The method of claim 1, wherein the pointer location indicator is operable to move such that traversing a hot zone causes the location indicator to appear on a screen of the second computing device.

3. The method of claim 1, further including changing an appearance of the pointer location indicator.

4. The method of claim 3, wherein an appearance of the pointer location indicator is responsive to input received by the second computing device.

5. The method of claim 4, wherein the appearance of the pointer location indicator is responsive to input received via a keyboard of the second computing device.

6. The method of claim 4, wherein the appearance of the pointer location indicator is indicative of a change in the effect of moving the pointing device.

7. The method of claim 4, wherein the input includes at least one keyboard button being pressed.

8. The method of claim 1, wherein the touch screen device is operable to respond to movement of the pointing device of the second computing device by enacting a response that would be enacted when a user applied an interaction to the touch screen, the interaction selected from the group of a multi-touch pinch an a multi-touch spread.

9. The method of claim 1, wherein the touch screen device is operable to interpret movement of the pointing device as a multi-touch command.

10. The method of claim 9, wherein the multi-touch command is selected from the group of pinch, spread, and rotate.

11. The method of claim 9, wherein indications of one or more of a keyboard button and a mouse button being pressed are received to cause interpretation of movement of the pointing device as a multi-touch command.

12. A touch screen device including:
an input operable to receive indications of operation of a pointing device coupled to a second computing device; and
a touch screen operable to display a pointer location indicator, the pointer location indicator operable to move responsively to movement of the pointing device.

13. The touch screen device of claim 12, wherein the pointer location indicator is operable to move such that traversing a hot zone of the touch screen causes the location indicator to appear on a screen of the second computing device.

14. The touch screen device of claim 12, wherein the touch screen device is operable to change the appearance of the pointer location indicator in response to information received via the input.

15. A computer readable medium containing non-transitory instructions thereon, that when interpreted by at least one processor cause the at least one processor to:
display a pointer location indicator on the touch screen device, the pointer location indicator operable to move responsively to movement of a pointing device of a second computing device.

16. The computer readable medium of claim 15, wherein the instructions are embodied in hardware description language suitable for one or more of describing, designing, organizing, fabricating, or verifying hardware.

17. The computer readable medium of claim 15, wherein the pointer location indicator is operable to move such that traversing a hot zone of the display causes the location indicator to appear on a screen of the second computing device.

18. The computer readable medium of claim 15, wherein an appearance of the pointer location indicator is responsive to input received via a keyboard of the second computing device.

19. The computer readable medium of claim 18, wherein an appearance of the pointer location indicator is indicative of a change in the effect of moving the pointing device.

20. The computer readable medium of claim 15, wherein the processor is further caused to respond to movement of the pointing device of the second computing device by enacting a response that would be enacted when a user applied an interaction to the touch screen, the interaction selected from the group of a multi-touch pinch an a multi-touch spread.
